(19) United States
(12) Patent Application Publication
(10) Pub. No.: US 2017/0124390 A1
(43) Pub. Date: May 4, 2017

(54) IMAGE PROCESSING APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventors: Katsuya KOYANAGI, Kanagawa (JP); Shigeru OKADA, Kanagawa (JP); Shintaro ADACHI, Kanagawa (JP); Hiroyuki KISHIMOTO, Kanagawa (JP); Kunihiko KOBAYASHI, Kanagawa (JP); Akane YOSHIZAKI, Kanagawa (JP)

(73) Assignee: FUJI XEROX CO., LTD., Tokyo (JP)

(21) Appl. No.: 15/085,211

(22) Filed: Mar. 30, 2016

(30) Foreign Application Priority Data
Nov. 2, 2015 (JP) 2015-216024

(51) Int. Cl. G06K 9/00

(52) U.S. Cl. CPC G06K 9/00456; G06K 9/00483

(57) ABSTRACT

An image processing apparatus includes an acquisition unit that acquires image information of an image formed on an original document, and a sorting unit that, using the image information acquired by the acquisition unit, sorts the image in accordance with one or both of a first recognition operation and a second recognition operation in response to an operation result of the one of the first recognition operation and the second recognition operation, the first recognition operation configured to sort the image according to a feature quantity of the image, the second recognition operation configured to sort the image according to character information of the image.

### CROSS-REFERENCE TO RELATED APPLICATIONS

This application is based on and claims priority under 35 USC 119 from Japanese Patent Application No. 2015-216024 filed Nov. 2, 2015.

### BACKGROUND

### Technical Field

The present invention relates to an image processing apparatus, an image processing method, and a non-transitory computer readable medium.

### SUMMARY

According to an aspect of the invention, there is provided an image processing apparatus. The image processing apparatus includes an acquisition unit that acquires image information of an image formed on an original document, and a sorting unit that, using the image information acquired by the acquisition unit, sorts the image in accordance with one or both of a first recognition operation and a second recognition operation in response to an operation result of the one of the first recognition operation and the second recognition operation. The first recognition operation is configured to sort the image according to a feature quantity of the image, and the second recognition operation is configured to sort the image according to character information of the image.

### BRIEF DESCRIPTION OF THE DRAWINGS

Exemplary embodiment of the present invention will be described in detail based on the following figures, wherein:

FIG. 1 generally illustrates an image processing system of an exemplary embodiment;

FIG. 2 illustrates a hardware configuration of an image reading apparatus of the exemplary embodiment;

FIG. 3 illustrates a hardware configuration of a terminal apparatus of the exemplary embodiment;

FIG. 4 is a block diagram of a functional configuration of the terminal apparatus of the exemplary embodiment;

FIG. 5 illustrates an example of an optical character recognition (OCR) operation and a border recognition operation;

FIG. 6 is a flowchart illustrating a routine of a process of the image processing system;

FIG. 7 illustrates an example of a reliability table; and

FIG. 8 is a flowchart illustrating a routine of a process that is performed with a higher priority placed on the OCR recognition operation.

### DETAILED DESCRIPTION

An exemplary embodiment of the present invention is described below with reference to the drawings.

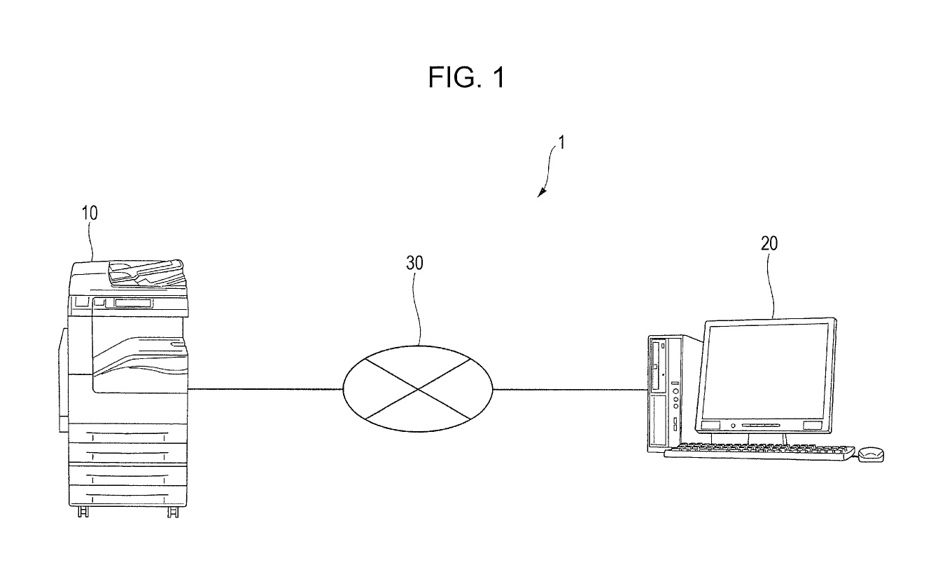

The whole configuration of an image processing system 1 of the exemplary embodiment described first. FIG. 1 generally illustrates the image processing system 1 of the exemplary embodiment. The image processing system 1 of the exemplary embodiment sorts original documents, such as reports. More specifically, the image processing system 1 of the exemplary embodiment sorts original documents, such as reports. More specifically, various types of original documents including a “statement of delivery” and a “bill” are set on the image processing system 1 and the image processing system 1 sorts the original documents according to contents of the original documents. By sorting the original documents, a user verifies items written on the original document in a sorted state, and processes the original document in accordance with a process flow predetermined on each sorting classification.

As illustrated in FIG. 1, the image processing system 1 includes an image reading apparatus 10, and a terminal apparatus 20. The image reading apparatus 10 generates image data (image information) by reading an image formed on an original document. The terminal apparatus 20 receives the image information from the image reading apparatus 10 via a network 30 and sorts the received image information.

The image reading apparatus 10 having a scan function reads an image formed on an original document (sheet), such as a report, and generates image information indicating the read image (hereinafter referred to as “original document image information”). The image reading apparatus 10 may be a scanner device, for example, and is based on a charge-coupled device (CCD) system or a contact image sensor (CIS) system. In the CCD system, a document is irradiated with a light beam, and a light beam reflected from the document is then collected via a lens. In the CIS system, a document is irradiated with a light beam from a light emitting diode (LED), and a light beam reflected from the document is received by a CIS sensor. The image reading apparatus 10 may have, in addition to the scan function, a print function, a copy function, or a facsimile function.

The terminal apparatus 20 receives via the network 30 the original document image information generated by the image reading apparatus 10, and sorts the original document using the received original document image information (namely, sorts the images formed on the original document). A personal computer (PC) may be used for the terminal apparatus 20. In accordance with the exemplary embodiment, the terminal apparatus 20 has a function serving as an image processing apparatus.

As described in detail below, the terminal apparatus 20 sorts the original document by performing an operation to recognize characters (including numbers, symbols, and marks) contained in an original document (the original document image information) through optical character recognition (OCR), and an operation to recognize borders contained in the original document. The OCR is a technique that analyzes the characters in image data and converts the characters into character data to be handled by a computer. The borders represent lines vertically or horizontally drawn to delineate or enclose items, and are considered to be an example of information representing a feature quantity of an image.

An operation to recognize the character information contained in the original document through OCR and sort the recognized character information may also be referred to as an OCR recognition operation. An operation to recognize and sort the borders contained in the original document may also be referred to as a border recognition operation. In accordance with the exemplary embodiment, the border recognition operation is used as an example of a first recognition operation. The OCR recognition operation is used as an example of a second recognition operation.

The network 30 is a communication network that is used for information communication between the image reading apparatus 10 and the terminal apparatus 20. The network 30 is a local area network (LAN), for example.

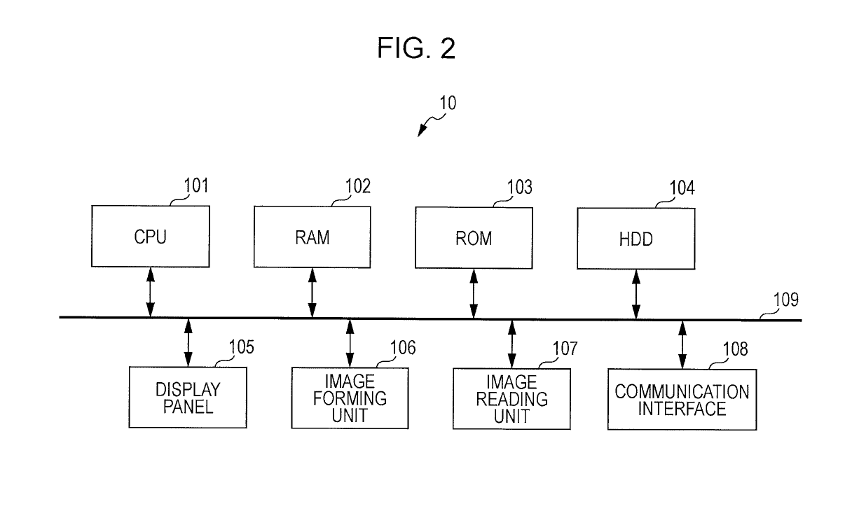

The hardware configuration of the image reading apparatus 10 is described below. FIG. 2 illustrates the hardware configuration of the image reading apparatus 10 of the exemplary embodiment. As illustrated in FIG. 2, the image reading apparatus 10 includes a central processing unit (CPU) 101, a random-access memory (RAM) 102, a read-only memory (ROM) 103, a hard disk drive (HDD) 104, a display panel 105, an image forming unit 106, an image reading unit 107, and a communication interface (hereinafter referred to as communication I/F) 108. These elements are interconnected to each other via a bus 109, and exchange data via the bus 109.

The CPU 101 executes a variety of programs including an operating system (OS) and applications. The RAM 102 serves as a working memory for the CPU 101. The ROM 103 stores the variety of programs to be executed by the CPU 101. The CPU 101 loads the variety of programs from the ROM 103 or the like to the RAM 102 to execute them. The CPU 101 thus performs each of the functions of the image reading apparatus 10. The HDD 104 stores data input to or output from a variety of software programs.

The display panel 105 receives a display of a variety of information or an operation input from the user.

The image forming unit 106 forms an image on a recording medium in response to input image data. The image forming unit 106 is an electrophotographic system that forms an image by transferring toner on a photoconductor drum to a recording medium or an ink-jet system that forms an image by ejecting ink onto a recording medium.

The image reading unit 107 reads an image formed on the recording medium, and generates the original document image information representing the read image.

The communication I/F 108 receives or transmits a variety of data from or to an external apparatus, such as the terminal apparatus 20, via the network 30.

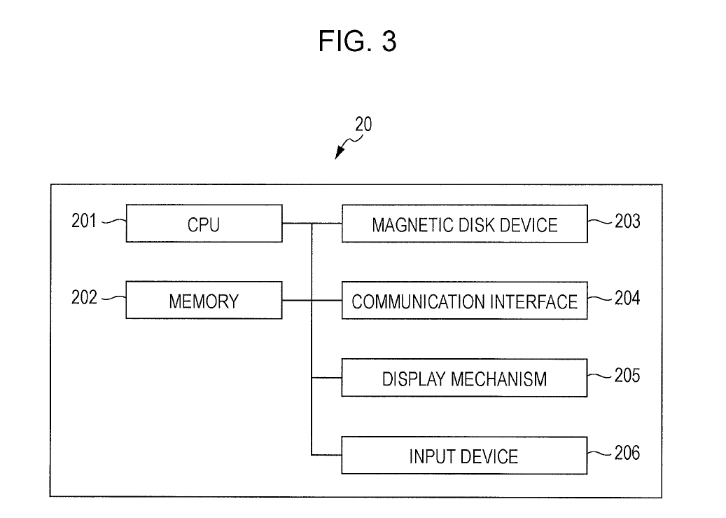

The hardware configuration of the terminal apparatus 20 is described below. FIG. 3 illustrates the hardware configuration of the terminal apparatus 20 of the exemplary embodiment. As illustrated in FIG. 3, the terminal apparatus 20 includes a CPU 201, a memory 202, and a magnetic disk device (HDD) 203.

The CPU 201 executes a variety of programs, including an OS and applications, thereby implementing functions of the terminal apparatus 20. The memory 202 stores the variety of programs and data used in the execution of the programs. The magnetic disk device 203 stores data input to the programs or data output from the programs. The terminal apparatus 20 further includes a communication I/F 204 configured to communicate with the outside, a display mechanism 205 including a video memory, a display, and the like, and an input device 206, such as a keyboard and a mouse.

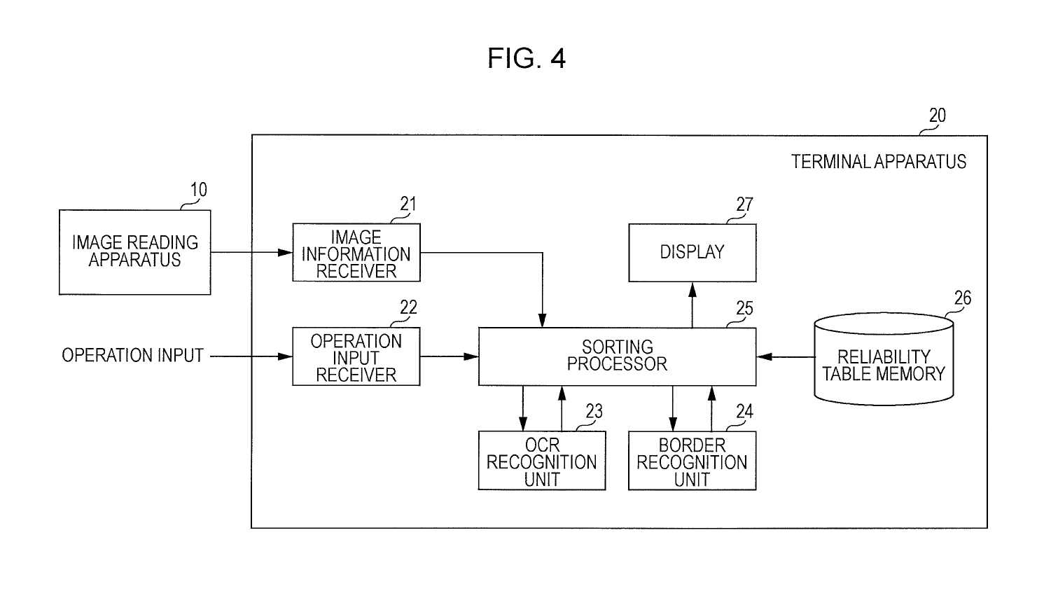

The functions and configuration of the terminal apparatus 20 are described below. FIG. 4 is a block diagram of a functional configuration of the terminal apparatus 20 of the exemplary embodiment.

The terminal apparatus 20 includes an image information receiver 21, an operation input receiver 22, an OCR recognition unit 23, and a border recognition unit 24. The image information receiver 21 receives the original document image information from the image reading apparatus 10 via the network 30. The operation input receiver 22 receives an operation input from the user. The OCR recognition unit 23 recognizes the original document image information. The border recognition unit 24 recognizes the original document image information through a border recognition operation.

The terminal apparatus 20 further includes a sorting processor 25, and a reliability table memory 26. The sorting processor 25 determines a sorting destination, based on operation result of the OCR recognition operation and operation result of the border recognition operation. The reliability table memory 26 stores a reliability table produced by a system administrator in advance.

The image information receiver 21 receives from the image reading apparatus 10 via the network 30 the original document image information that the image reading unit 107 has generated by reading an image formed on the original document.

The operation input receiver 22 receives an operation input from the user. For example, the operation input receiver 22 receives an operation input that specifies a sorting pattern when the original document is to be sorted. The sorting pattern indicates a sorting classification to which each original document belongs to. The user specifies the sorting pattern by considering the contents of each set document. The sorting pattern is described below in detail.

The OCR recognition unit 23 recognizes the original document image information through the OCR recognition operation. More specifically, the OCR recognition unit 23 recognizes, through the OCR recognition operation, characters contained in the original document image information received by the image information receiver 21. Based on information of the recognized characters (a character string), the OCR recognition unit 23 sorts the original document to one of plural sorting items predetermined for the OCR recognition operation.

The border recognition unit 24 recognizes the original document image information through the border recognition operation. More specifically, the border recognition unit 24 horizontally and vertically scans the original document image information received by the image information receiver 21, and recognizes a line of consecutive black points having a predetermined length or longer as a border. Based on the information of the recognized border, the border recognition unit 24 sorts the original document to one of plural sorting items predetermined for the border recognition operation.

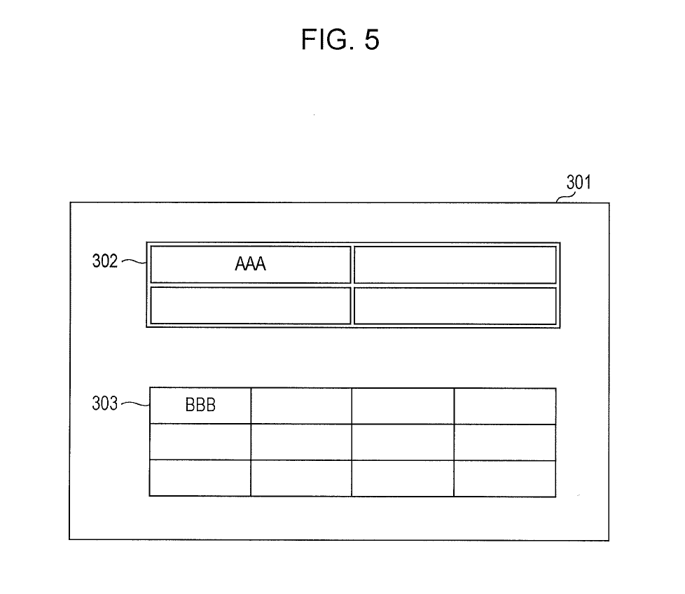

The OCR recognition operation and the border recognition operation are described with reference to FIG. 5. FIG. 5 illustrates examples of the OCR recognition operation and the border recognition operation. An original document 301 of FIG. 5 includes a drawing 302 and a drawing 303, formed of borders. The drawing 302 includes a character string “AAA” and the drawing 303 includes a character string “BBB”.

In the OCR recognition operation, the OCR recognition unit 23 performs character recognition, thereby learning that the character string “AAA” and the character string “BBB” are drawn in the original document 301. If a sorting item is predetermined for the OCR recognition operation with the character string “AAA” and the character string “BBB” drawn in the original document 301, the OCR recognition unit 23 sorts the original document to the predetermined sorting item. When the sorting is performed in the OCR recognition operation, any information related to the characters, such as the size and position (coordinates information) of the characters, may be used.

In the border recognition operation, the border recognition unit 24 recognizes that the borders, such as the drawing 302, and the drawing 303, are drawn in the original document 301. If a sorting item is predetermined for the border recognition operation with the drawing 302 and the drawing 303 drawn in the original document 301, the border recognition unit 24 sorts the original document to the predetermined sorting item. When the sorting is performed in the border recognition operation, any information related to the borders, such as the type, size and position (coordinates information) of the borders, may be used.

The OCR recognition operation and the border recognition operation are thus performed.

The sorting processor 25 determines whether one or both of the OCR recognition operation and the border recognition operation are to be used. The sorting processor 25 determines a final sorting destination of the original document by performing one or both of the OCR recognition operation and the border recognition operation. The sorting processor 25 herein determines the type of the original document as the final sorting destination of the original document.

A recognition operation having priority, namely, the OCR recognition operation or the border recognition operation, is determined on each sorting pattern specified by the user in the sorting. Additionally, depending on the original documents, some documents may be sorted more easily by recognizing characters rather than borders, and the other documents may be sorted more easily by recognizing borders rather than characters. In advance, the system administrator may determine which recognition operation to prioritize over the other on a per sorting pattern basis. In accordance with the sorting pattern specified by the user, the sorting processor 25 prioritizes one recognition operation over the other recognition operation between the OCR recognition operation and the border recognition operation. In the exemplary embodiment, an example of the condition to be specified by the user is the sorting pattern.

The sorting processor 25 prioritizes one of the OCR recognition operation and the border recognition operation, and then determines whether to perform the other recognition operation, based on the operation result of the one recognition operation performed with priority. The reliability table stored in the reliability table memory 26 associates the operation result of the OCR recognition operation with whether to perform the border recognition operation in succession to the OCR recognition operation. Also, the reliability table stored in the reliability table memory 26 associates the operation result of the border recognition operation with whether to perform the OCR recognition operation in succession to the border recognition operation. For this reason, subsequent to the execution of one recognition operation, the sorting processor 25 references the reliability table to determine whether to perform the other recognition operation.

Based on the operation result of the one recognition operation performed prior to the other recognition operation out of the OCR recognition operation and the border recognition operation, the sorting processor 25 determines the sorting destination of the original document using the operation result of one or both of the recognition operations.

The reliability table memory 26 stores the reliability table produced in advance. The reliability table lists information that is used to determine whether to perform the OCR recognition operation and the border recognition operation. The reliability table also lists information that is used to determine the sorting destination of the original document in accordance with the operation result of the OCR recognition operation and the operation result of the border recognition operation. The reliability table is described in detail below. In the exemplary embodiment, the reliability table is used as an example of a predetermined association relationship.

The display 27 displays the sorting results provided by the sorting processor 25 to the user.

Each of these functions in the terminal apparatus 20 is implemented when software resources cooperate with hardware resources. More specifically, the CPU 201 reads a program configured to implement the functions of the terminal apparatus 20 from the magnetic disk device 203 onto the memory 202, and executes the program. The CPU 201 thus implements the functions. The reliability table memory 26 may be implemented by the magnetic disk device 203, for example. The display 27 may be implemented by the display mechanism 205, for example.

In the exemplary embodiment, the image information receiver 21 serves in function as an example of an acquisition unit. The OCR recognition unit 23, the border recognition unit 24, and the sorting processor 25 serve in function as an example of a sorting unit.

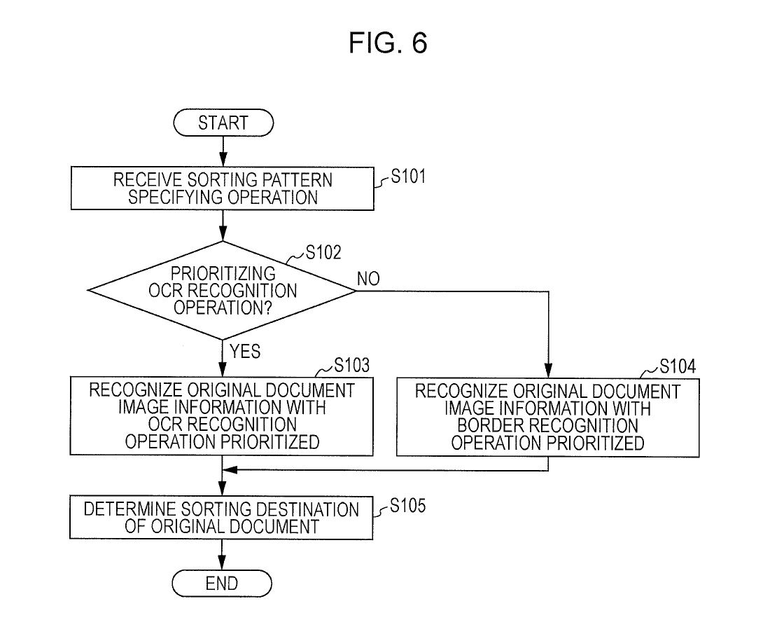

A routine of a process of the image processing system 1 is described below. FIG. 6 is a flowchart illustrating the routine of the process of the image processing system 1. An original document is set as a sorting target on the image reading apparatus 10 by the user in an initial state.

The user specifies the sorting pattern in response to the set original document. The operation input receiver 22 receives an operation that specifies the sorting pattern (step S101). The sorting pattern indicates the classification to which an original document belongs. More specifically, the sorting pattern of an ordering job, a delivery job, or the like is determined on a per job basis, on a per case basis, or on a per customer basis. In the exemplary embodiment, the user simply specifies a sorting pattern responsive to the set original document from among plural sorting patterns prepared in advance.

The user operates the image reading apparatus 10 to read the set original document. The original document image information thus generated is transmitted to the terminal apparatus 20.

The sorting processor 25 determines whether to prioritize the OCR recognition operation over the border recognition operation in accordance with the specified sorting pattern (step S102). If the determination result in step S102 is yes, the original document image information is recognized through the OCR recognition operation (step S103).

In step S103, the OCR recognition unit 23 recognizes the original document image information through the OCR recognition operation. The sorting processor 25 references the reliability table to determine whether to perform the border recognition operation in response to the operation result of the OCR recognition operation. In other words, if the reliability table associates the operation result of the OCR recognition operation with the execution of the border recognition operation, the sorting processor 25 determines that the border recognition operation is to be performed. If the border recognition operation is determined to be performed, the border recognition unit 24 recognizes the original document image information through the border recognition operation.

If the determination result in step S102 is no, the original document image information is recognized through the border recognition operation with priority (step S104). In step S104, the border recognition unit 24 recognizes the original document image information through the border recognition operation. By referencing the reliability table, the sorting processor 25 determines whether to perform the OCR recognition operation in response to the operation result of the border recognition operation. In other words, if the reliability table associates the operation result of the border recognition operation with the execution of the OCR recognition operation, the OCR recognition operation is determined to be performed. If the OCR recognition operation is determined to be performed, the OCR recognition unit 23 recognizes the original document image information.

Subsequent to step S103 or step S104, the sorting processor 25 determines the sorting destination of the original document in response to the operation result of the OCR recognition operation and the operation result of the border recognition operation (step S105). The sorting destination of the original document is determined in response to the operation result of the recognition operation performed in step S103 and step S104. More specifically, the sorting destination of the original document is determined using one or both of the operation results of the OCR recognition operation and the border recognition operation. A type of original document is determined as the sorting destination of the original document from among types of original documents configured for the sorting pattern specified by the user. The routine of the process is thus complete.

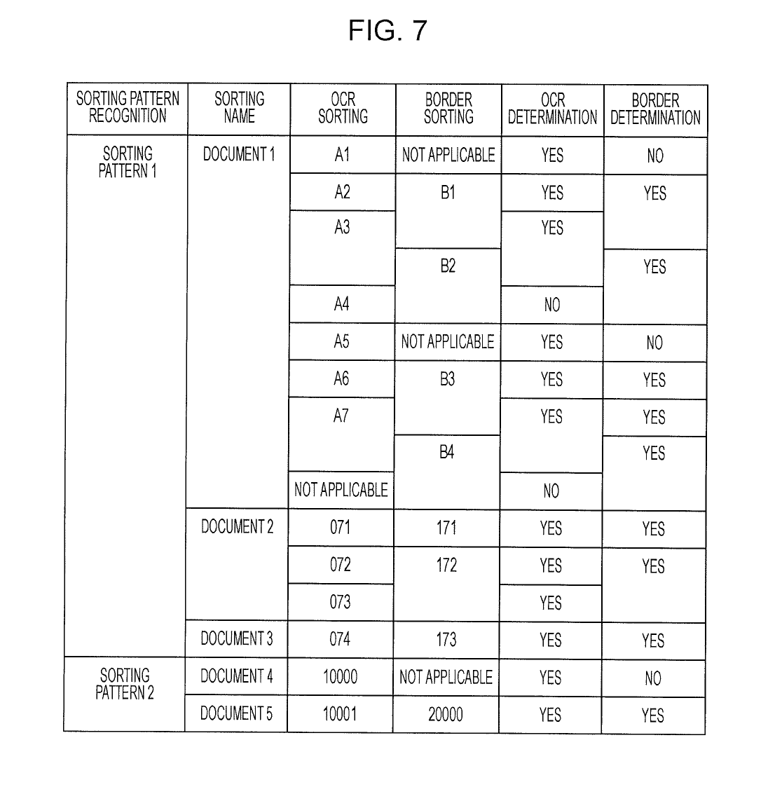

The reliability table is described below. FIG. 7 illustrates an example of the reliability table. The reliability table is produced by the system administrator who has learned formats of a variety of different original documents serving as sorting targets. More specifically, the system administrator has learned information concerning characters and borders drawn on each original document serving as a sorting target, and then produces the reliability table.

A “sorting pattern identification” represents a sorting pattern. As illustrated in FIG. 7, the sorting pattern identification lists a “sorting pattern 1”, and a “sorting pattern 2”. More specifically, the “sorting pattern 1” indicates a job of “delivery”, and the “sorting pattern 2” indicates a job of “completing a contract”.

A “sorting name” represents the type of an original document. As illustrated in FIG. 7, “document 1” and “document 2” are listed. More specifically, a “statement of delivery”, a “bill”, and the like are listed. Furthermore, three document types of “document 1”, “document 2”, and “document 3” are included in the classification of a “sorting pattern 1”. In other words, if the “sorting pattern” indicates a “delivery operation”, the three document types of “document 1”, “document 2”, and “document 3” are used. In the exemplary embodiment, the sorting processor 25 determines the document type listed under the “sorting name” to be the sorting destination of the original document.

An “OCR sorting” represents a sorting item for the OCR recognition operation according to which the original document is sorted. As illustrated in FIG. 7, the OCR recognition operation sorts original documents of the “document 1” to one of “A1” through “A7” sorting items. The sorting items “A1” through “A7” are associated in advance with the “document 1” serving as the sorting destination of the original documents.

If the “document 1” represents “statements of delivery”, the statements of delivery are typically issued from different sources. Some statements of delivery may be printed as an “invoice”. Other statements of delivery may be printed as a “certificate of delivery”. The type of documents is commonly handled as a statement of delivery, but a character string to be recognized by the OCR may be different from document to document. Even if the documents have the same “sorting name”, they are sorted to the sorting items “A1” through “A7”. For example, “A1” indicates an original document with “statement of delivery” printed thereon, and “A2” indicates an original document with “invoice” printed thereon.

If an original document is sorted to a “not applicable” classification in the OCR sorting, it means that the original document is not sorted to any of the sorting items “A1” through “A7”. In the “document 1” of the statement of delivery, only a single word “delivery” of statement of delivery instead of full wording “delivery of statement” may be printed in a given format. In such a case, the document may not be sorted to a statement of delivery through the OCR recognition operation. In view of such a case, the “not applicable” classification is included in the OCR sorting.

A “border sorting” represents a sorting item for the border recognition operation according to which the original document is sorted. As illustrated in FIG. 7, the border recognition operation sorts original documents of the “document 1” to one of “B1” through “B4” sorting items. The sorting items “B1” through “B4” are associated in advance with the “document 1” serving as the sorting destination of the original documents.

If the “document 1” represents “statements of delivery”, the statements of delivery are typically issued from different sources. Depending on the border structure of the borders, the documents may be sorted to four sorting items “B1” through “B4”. For example, all the original documents having “A2” under the “OCR sorting” are sorted to “B1” under the “border sorting”. On the other hand, some of the original documents having “A3” under the “OCR sorting” are sorted to “B1” under the “border sorting” while the other original documents having “A3” under the “OCR sorting” are sorted to “B2” under the “border sorting”.

In a “not applicable” classification under the border sorting, the original document is not sorted to any of the sorting items “B1” through “B4”. In the case of the “document 1”, some the statements of delivery may have no borders drawn in the format thereof, and may not be sorted according to border. In view of such a case, the original document may not be sorted to a statement of delivery through the border recognition operation. The border sorting classification “not applicable” is thus included.

An “OCR determination” is based on the operation result of the border recognition operation and indicates whether to perform the OCR recognition operation. Here, “yes” indicates that the OCR recognition operation is to be performed while “no” indicates the OCR recognition operation is not to be performed.

A “border determination” is based on the operation result of the OCR recognition operation and indicates whether to perform the border recognition operation. Here, “yes” indicates that the border recognition operation is to be performed while “no” indicates the border recognition operation is not to be performed.

“Yes” or “no” of the OCR recognition operation or the border recognition operation is determined in accordance with reliability of the operation result of the OCR recognition operation or the operation result of the border recognition operation.

For example, even if an original document is sorted to “A4” through the OCR recognition operation, reliability may not be high enough to determine that the “sorting name” is the “document 1”. On the other hand, if an original document is sorted to “B2” through the border recognition operation, reliability may be high enough to determine that the original document is the “document 1”, without the need to perform the OCR recognition operation. In such a case, the “OCR determination” is determined to be “no” while the “border determination” is determined to be “yes”.

If the “OCR sorting” is not applicable, the original document is not sortable through the OCR recognition operation, and the “OCR determination” is thus “no”. Similarly, if the “border sorting” is not applicable, the original document is not sortable through the border recognition operation, and the “border determination” is thus “no”.

Specific examples of the routine of the process based on the reliability table are described with reference to the reliability table of FIG. 7. The process herein corresponds to operations in steps S103 to S105 of FIG. 6. The user may now specify the “sorting pattern 1”.

A first specific example is described below. In this example, the OCR recognition operation may have sorted the original document to the sorting item “A2” with the OCR recognition operation having priority.

The sorting processor 25 references the reliability table, and checks the “border determination” responsive to “A2” under the “OCR sorting”. As listed in FIG. 7, the “border determination” responsive to “A2” is “yes”. For this reason, the border recognition operation is performed.

The reliability table indicates that the “border sorting” responsive to “A2” is “B1”. If the operation result provided by the border recognition unit 24 is “B1”, the operation result matches the information in the reliability table. The type of the original document responsive to the original document image information is determined to be the “document 1” that is the “sorting name” responsive to “A2” and “B1”. More specifically, the sorting processor 25 determines that the type of the original document is the “document 1” as the sorting destination of the original document. On the other hand, if the operation result provided by the border recognition unit 24 is not “B1”, the operation result fails to match the information in the reliability table. The type of the original document is not determined at this point of time.

The operation result provided by the border recognition unit 24 may simply determine whether an original document is sortable to “B1”, and does not necessarily have to determine whether the original document is sortable to “B2” or “B3” other than “B1”. In other words, the border recognition unit 24 checks a border drawn in the original document image information against a border sorted to “B1” to determine whether the border is sortable to “B1”.

In the exemplary embodiment, performing the OCR recognition operation first on the original document reduces the predetermined plural sorting items to select a smaller number of sorting items in the border recognition operation, and an operation to sort the original document to one of the selected sorting items is performed. In this example, the border recognition operation is performed with the predetermined sorting items “B1” through “B4” narrowed to “B1”.

A second specific example is described below. In this example, the border recognition operation may have sorted the original document to the sorting item “B3” with the border recognition operation having priority.

The sorting processor 25 references the reliability table, and checks the “OCR determination” responsive to “B3” under the “border sorting”. As listed in FIG. 7, the “OCR determination” responsive to “B3” is “yes”. For this reason, the OCR recognition operation is performed.

The reliability table indicates that the “OCR sorting” responsive to “B3” is “A6” or “A7”. If the operation result provided by the OCR recognition unit 23 is “A6” or “A7”, the operation result matches the information in the reliability table. The type of the original document responsive to the original document image information is determined to be the “document 1” that is the “sorting name” responsive to “B3”. More specifically, the sorting processor 25 determines that the type of the original document is the “document 1” as the sorting destination of the original document. On the other hand, if the operation result provided by the OCR recognition unit 23 is neither “A6” nor “A7”, the operation result fails to match the information in the reliability table. The type of the original document is not determined at this point of time.

The operation result provided by the OCR recognition unit 23 may simply determine whether an original document is sortable to “A6” or “A7”, and does not necessarily have to determine whether the original document is sortable to “A1” or “A2” other than “A6” or “A7”. In other words, the OCR recognition unit 23 checks the character string printed on the original document against the character string sorted to “A6” or the character string sorted to “A7” to determine whether the character string is sortable to “A6” or “A7”.

In the exemplary embodiment, performing the border recognition operation first on the original document reduces the predetermined plural sorting items to select a smaller number of sorting items in the OCR recognition operation, and an operation to sort the original document to one of the selected sorting items is performed. In this example, the OCR recognition operation is performed with the predetermined sorting items “A1” through “A7” narrowed to “A6” and “A7”.

A third specific example is described below. In this example, the border recognition operation may have sorted the original document to the sorting item “B4” with the border recognition operation having priority.

The sorting processor 25 references the reliability table, and checks the “OCR determination” responsive to “B4” under the “border sorting”. As listed in FIG. 7, the “border determination” responsive to “B4” lists “yes” and “no”. In this case, the OCR recognition operation is not performed, and the sorting destination of the original document is determined using only the operation result of the border recognition operation. More specifically, the sorting destination of the original document is determined to be the “document 1” responsive to “B4”.

If the “OCR determination” is “no”, the reliability of the operation result of the OCR recognition operation is low, and the original document is to be sorted through the border recognition operation. If the “OCR determination” lists “yes” and “no”, the sorting destination of the original document is determined using only the operation result of the border recognition operation, regardless of the operation result of the OCR recognition operation.

If the “border determination” lists “yes” and “no”, an operation similar to the operation described above is performed. More specifically, the sorting destination of the original document is determined using only the operation result of the OCR recognition operation, regardless of the operation result of the border recognition operation.

A fourth specific example is described below. In this example, the OCR recognition operation has been performed with priority thereon, but the original document is not sorted through the OCR recognition operation to any sorting item of the “OCR sorting” belonging to the “sorting pattern 1”.

If the original document is not sorted to any of the sorting items through the OCR recognition operation, the border recognition operation is then performed. The sorting destination of the original document is determined using only the operation result of the border recognition operation.

If the original document is not sorted to any of “A1” through “A7”, and “071” through “073”, and “074” as the sorting items of the specified “sorting pattern 1” through the OCR recognition operation, the border recognition operation is performed. If the operation result of the border recognition operation is “B1”, for example, the type of the original document responsive to the original document image information is determined to be the “document 1” as the “sorting name” responsive to “B1”. More specifically, the sorting processor 25 determines the type of the original document to be the “document 1” as the sorting destination of the original document. For example, if the operation result of the border recognition operation is “173”, the sorting processor 25 determines the sorting destination of the original document to be the “document 3” as the “sorting name” responsive to “173”.

In the fourth specific example, the OCR recognition operation has priority. An operation similar to the operation described above is performed if the original document is not sorted to any of the sorting items through the border recognition operation. More specifically, the border recognition operation is successively followed by the OCR recognition operation, and the sorting destination of the original document is determined by using only the operation result of the OCR recognition operation.

In the reliability table of the exemplary embodiment, the number of sorting items for the OCR recognition operation is not necessarily equal to the number of sorting items of the border recognition operation under a single “sorting name” (namely, an original document type). In other words, the sorting items of the OCR recognition operation do not necessarily correspond to the sorting items of the border recognition operation on a one-to-one basis. For example, if the “sorting name” is the “document 1” in the reliability table of FIG. 7, the number of sorting items of the OCR recognition operation is seven, namely, “A1” through “A7”, and the number of sorting items of the border recognition operation is four, namely, “B1” through “B4”. Furthermore, the classification of “A3” under the “OCR sorting” corresponds to the two classifications of “B1” and “B2” under the “border sorting”.

As described above in the reliability table of the exemplary embodiment, the sorting items of the OCR recognition operation and the sorting items of the border recognition operation are associated with the types of the original documents serving as the sorting targets. The original document type is uniquely determined even if the sorting items of the OCR recognition operation do not correspond to the sorting items of the border recognition operation on a one-to-one basis.

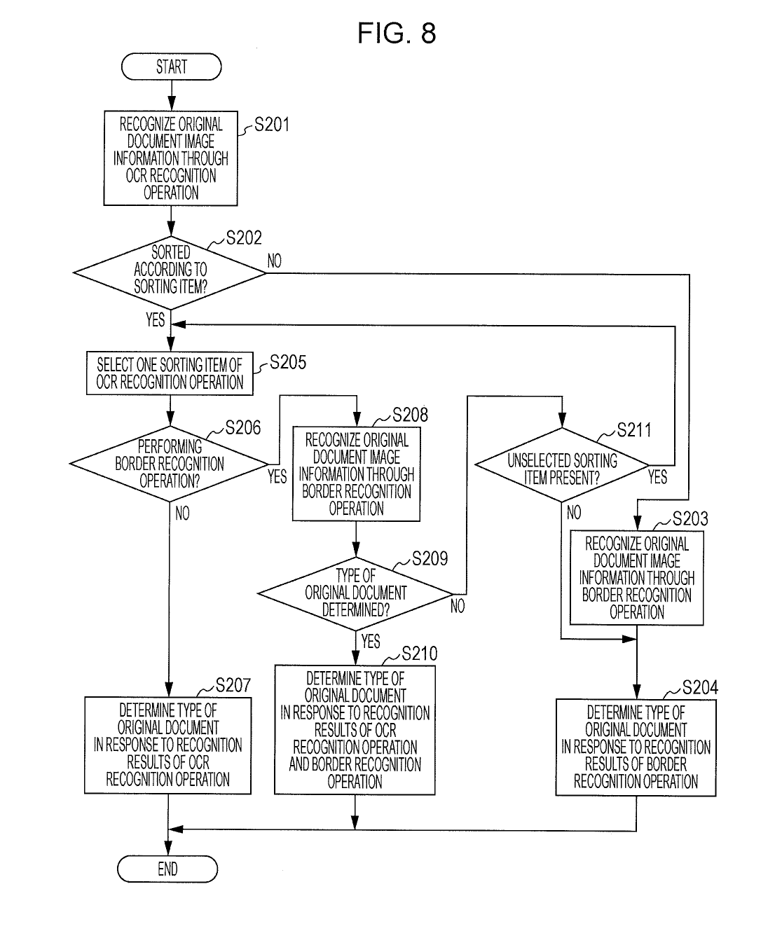

A routine of a process of the OCR recognition operation having priority is described in detail. FIG. 8 is a flowchart illustrating the routine of the process that is performed with the OCR recognition operation having priority. The process of FIG. 8 corresponds to operations in steps S103 and S105 of FIG. 6.

If the OCR recognition operation has priority, the OCR recognition unit 23 recognizes the original document through the OCR recognition operation (step S201). The sorting processor 25 determines the sorting item to which the OCR recognition operation has sorted the original document (the sorting item listed under the “OCR sorting” in the reliability table of FIG. 7) (step S202). If the sorting processor 25 determines that the original document image information is not determined to be any of the sorting items (no branch from step S202), the border recognition unit 24 recognizes the original document image information through the border recognition operation (step S203). The sorting processor 25 references the reliability table and identifies the type of the original document corresponding to the sorting item sorted through the border recognition operation (the sorting item listed under the “border sorting” in the reliability table of FIG. 7). More specifically, the sorting processor 25 determines the type of the original document (the sorting destination) using only the operation result of the border recognition operation (step S204). The routine of the process thus ends.

If the original document is sorted to one of the sorting items in step S202 (yes branch from step S202), there is a possibility that the original document is sorted to plural sorting items. More specifically, the operation result of the OCR recognition operation does not uniquely determine the sorting item under the “OCR sorting” in the reliability table of FIG. 7 but provides plural candidates. If there are plural candidates, one candidate after another may be selected in accordance with any type of order, such as an order that may be predetermined for the sorting items, before the type of the original document is determined.

The sorting processor 25 herein selects one of the sorting item candidates in the OCR recognition operation in accordance with any type of order (step S205). The sorting processor 25 references the reliability table to determine whether to perform the border recognition operation in accordance with the selected sorting item (step S206). Upon determining that the border recognition operation is not to be performed (no branch from step S206), the sorting processor 25 references the reliability table to identify the type of the original document responsive to the selected sorting item. More specifically, the sorting processor 25 determines the type of the original document in response to the operation result of the OCR recognition operation (step S207). The routine of the process thus ends.

If the sorting processor 25 determines in step S206 that the border recognition operation is to be performed (yes branch from step S206), the border recognition unit 24 recognizes the original document image information through the border recognition operation (step S208). The sorting processor 25 references the reliability table and then determines whether the type of the original document is determined, in response to the operation result of the OCR recognition operation and the operation result of the border recognition operation (step S209).

Operation in step S209 is described with reference to the reliability table of FIG. 7. The sorting processor 25 references the reliability table and identifies the sorting item of the “border sorting” responsive to the sorting item of the “OCR sorting” selected in step S205. If the sorting item of the “border sorting” identified herein matches the operation result of the border recognition operation in step S208, the type of the original document is determined. On the other hand, if the sorting item of the “border sorting” identified herein fails to match the operation result of the border recognition operation in step S208, the type of the original document is not yet determined at this point of time.

If the determination result in step S209 is yes, the type of the original document is determined in response to the operation result of the OCR recognition operation and the operation result of the border recognition operation (step S210). The routine of the process thus ends.

On the other hand, if the determination result in step S209 is no, the sorting processor 25 determines whether there is any unselected sorting item from among the sorting items sorted in the OCR recognition operation in step S201 (step S211). If there is an unselected sorting item (yes branch from step S211), processing returns to step S205. If all sorting items are selected (no branch from step S211), processing proceeds to step S204. If processing proceeds to step S204, the type of the original document is determined in response to the operation result of the border recognition operation in step S208.

The case with the OCR recognition operation having priority has been described with reference to FIG. 8. A similar process is performed when the border recognition operation has priority. More specifically, if the border recognition operation has priority, the border recognition operation recognizes the original document image information. The OCR recognition operation is then performed in response to the operation result of the border recognition operation, and the type of the original document responsive to the original document image information is determined.

As described above, the terminal apparatus 20 of the exemplary embodiment sorts the original document using the OCR recognition operation and the border recognition operation. In this case, in response to the operation result of one of the OCR recognition operation and the border recognition operation, the terminal apparatus 20 determines whether to sort the original document through the other of the OCR recognition operation and the border recognition operation. The terminal apparatus 20 then determines the sorting destination of the original document, based on one or both of the operation results of the OCR recognition operation and the border recognition operation.

In accordance with the exemplary embodiment, even if the type of the original document is not determined in response to the operation result of one of the OCR recognition operation and the border recognition operation, the other recognition operation is performed. The type of the original document is identified based on the operation results of the two recognition operations.

In accordance with the exemplary embodiment, which of the OCR recognition operation and the border recognition operation has priority is determined on a per sorting pattern basis. The present invention is not limited to this method. For example, the user may directly specify which of the OCR recognition operation and the border recognition operation has priority. In such a case, the operation input receiver 22 receives an operation input that specifies which of the OCR recognition operation and the border recognition operation has priority.

In accordance with the exemplary embodiment, the terminal apparatus 20 sorts the original document using two recognition operations, namely, the OCR recognition operation and the border recognition operation. Another recognition operation (such as a recognition operation using QR code (registered trademark)) may be additionally used. In such a case, the terminal apparatus 20 sorts the original document using the QR code if the original document contains QR code. If the original document contains no QR code, the terminal apparatus 20 sorts the original document using the OCR recognition operation and the border recognition operation from among the plural recognition operations.

In the exemplary embodiment, the image reading apparatus 10 may implement the functions of the terminal apparatus 20. In such a case, the image reading apparatus 10 reads an image formed on an original document, and determines the type of the original document responsive to the read original document image information by referencing the reliability table. In such a case, the image reading apparatus 10 may be an example of an image processing apparatus.

A computer program to implement the exemplary embodiment of the present invention may be supplied using a communication system. The computer program may also be supplied using a recording medium, such as a compact disk read-only memory (CD-ROM).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an acquisition unit that acquires image information of an image formed on an original document; and
a sorting unit that, using the image information acquired by the acquisition unit, sorts the image in accordance with one or both of a first recognition operation and a second recognition operation in response to an operation result of one recognition operation as the one of the first recognition operation and the second recognition operation, the first recognition operation configured to sort the image according to a feature quantity of the image, the second recognition operation configured to sort the image according to character information of the image.

2. The image processing apparatus according to claim 1, wherein the sorting unit performs the other recognition operation as the other of the first recognition operation and the second recognition operation subsequent to the one recognition operation if a predetermined association relationship specifies that execution of the other recognition operation is associated with the operation result of the one recognition operation.

3. The image processing apparatus according to claim 1, wherein a plurality of items are respectively predetermined for the first recognition operation and the second recognition operation and the sorting unit recognizes which item the image belongs to in each of the first recognition operation and the second recognition operation, and
wherein if the other recognition operation is performed subsequent to the one recognition operation, the sorting unit reduces the predetermined items to select a smaller number of items in response to the operation result of the one recognition operation and recognizes in the other recognition operation which of the selected items the image belongs to.

4. The image processing apparatus according to claim 3, wherein the items predetermined for each recognition operation are associated in advance with a sorting destination of the image on a per item basis, and
wherein the sorting unit sorts the image to the sorting destination that is associated with the item to which the image is recognized to belong in the other recognition operation.

5. The image processing apparatus according to claim 1, wherein if a plurality of candidates are output as operation results of the one recognition operation, the sorting unit selects the candidates in accordance with a predetermined order until the sorting destination of the image is determined, and sorts the image in accordance with one or both of the first recognition operation and the second recognition operation using the selected candidate.

6. The image processing apparatus according to claim 1, wherein the sorting unit determines which of the first recognition operation and the second recognition operation is to be performed first depending on a condition specified by a user.

7. The image processing apparatus according to claim 1, wherein the feature quantity of the image comprises a border contained in the image.

8. An image processing apparatus, comprising:
an acquisition unit that acquires image information of an image formed on an original document; and
a sorting unit that, using the image information acquired by the acquisition unit, sorts the image in accordance with one or both of a first recognition operation and a second recognition operation different from the first recognition operation in response to an operation result of the one of the first recognition operation and the second recognition operation.

9. An image processing method comprising:
acquiring image information of an image formed on an original document; and
with the acquired image information used, sorting the image in accordance with one or both of a first recognition operation and a second recognition operation in response to an operation result of the one of the first recognition operation and the second recognition operation, the first recognition operation configured to sort the image according to a feature quantity of the image, the second recognition operation configured to sort the image according to character information of the image.

10. A non-transitory computer readable medium storing a program causing a computer to execute a process for processing images, the process comprising:
acquiring image information of an image formed on an original document; and
with the acquired image information used, sorting the image in accordance with one or both of a first recognition operation and a second recognition operation in response to an operation result of the one of the first recognition operation and the second recognition operation, the first recognition operation configured to sort the image according to a feature quantity of the image, the second recognition operation configured to sort the image according to character information of the image.
